(19) United States
(12) Patent Application Publication
(10) Pub. No.: US 2013/0093887 A1
(43) Pub. Date: Apr. 18, 2013

(54) Obstacle Detection System and Obstacle Detection Method Thereof

(71) Applicants: Chih-Huan Wu, Kaohsiung City (TW); Chung-Fang Chien, Taipei City (TW)

(72) Inventors: Chih-Huan Wu, Kaohsiung City (TW); Chung-Fang Chien, Taipei City (TW)

(73) Assignee: ALTEK AUTOTRONICS CORP., Hsinchu (TW)

(21) Appl. No.: 13/348,148

(22) Filed: Jan. 11, 2012

(30) Foreign Application Priority Data
Oct. 13, 2011 (TW) 100137072

(51) Int. Cl. H04N 7/18

(52) U.S. Cl. 348/148; 348/E07.085

(57) ABSTRACT

An obstacle detection system and a method thereof The obstacle detection system comprises an object detection module used to generate a detected distance and a detected direction of a external obstacle; a camera module used to capture a camera image including an obstacle image; a calculation module used to calculate a first region for the obstacle image in the camera image; and an object search module used to execute a first image processing on the camera image within the first region to obtain the obstacle image. If no obstacle is found within the first region, the calculation module is used to calculate a second region. The object search module is used to execute a second image processing within the second region to obtain the obstacle image.

### CROSS-REFERENCE TO RELATED APPLICATION

This application claims the benefit of priority to Taiwan Patent Application No. 100137072, filed on Oct. 13, 2011, in the Taiwan Intellectual Property Office, the disclosure of which is incorporated herein in its entirety by reference.

### BACKGROUND OF THE INVENTION

1. Field of the Invention

The present invention relates to an obstacle detection system and an obstacle detection method thereof, in particular to the obstacle detection system and method thereof integrated with radar, sonar and image technologies for detecting an obstacle, capturing an image within a surrounding environment of a motor vehicle, and marking a position and a distance of the obstacle in the image.

2. Description of the Related Art

As science and technology advance, a reversing radar has become one of the basic equipments of a motor vehicle. Generally, a reversing radar includes an ultrasonic sensor installed at the rear of the motor vehicle, such that when the motor vehicle is shifted to a reverse gear, the ultrasonic sensor is turned on to emit ultrasonic signals. When the ultrasonic signal encounters an obstacle, the ultrasonic signal returns and is received by the ultrasonic sensor. Further, a siren installed in the motor vehicle delivers an obstacle message to warn a driver and assist the driver to park the motor vehicle successfully.

At present, there is a better reversing radar available in the market and further using a camera to capture images at the rear side, and using a display device to display the images of the rear side for viewing by a driver. Therefore, the driver can know about the obstacle information at the rear of the motor vehicle by an audio prompt, and further learn about the obstacle position at the rear of the motor vehicle by viewing the images displayed on the display device. It may even calculate the time of returning ultrasonic waves to obtain the distance between the obstacle and the rear of the motor vehicle, and display the distance numerically on the display device so as to provide comprehensive information to the driver.

However, the application of the aforementioned reversing radar device still cannot provide relative positions of the rear of the motor vehicle and the obstacle in space. Although the display device shows the numeric information of the distance, yet it appear to be only numbers for the drivers, and it still has to further convert the numerical concept into the actual distance concept, so that the user cannot obtain the image concept that directly represents the obstacle distance from the screen. Thus, improvements are required to provide better reversing information and reduce the chance of accidents when the driver reverses a motor vehicle.

### SUMMARY OF THE INVENTION

In view of the problems of the prior art, it is a primary objective of the present invention to provide an obstacle detection system and an obstacle detection method thereof to overcome the problem of the prior art that fails to provide drivers more detailed information between a motor vehicle and an obstacle while the driver is driving.

To achieve the aforementioned objective, the present invention provides an obstacle detection system applied in a mobile vehicle. The obstacle detection system comprises an object detection module, a camera module, a calculation module and an object search module. The object detection module is provided for generating a detected distance and a detected direction of at least one external obstacle. The camera module is provided for capturing a camera image, and the camera image includes an obstacle image. The calculation module calculates a first region for the obstacle image in the camera image according to a detected distance and a detected direction. The object search module is provided for executing a first image processing on the camera image within the first region to obtain the obstacle image.

Preferably, when the object search module obtains the obstacle image, the calculation module calculates a distance from the obstacle.

Preferably, the calculation module further calculates the distance according to driving information of a mobile vehicle.

Preferably, the obstacle image is highlighted in the camera image.

Preferably, the object detection module is a sonar detection device or a radar detection device.

Preferably, if the object search module cannot search the obstacle image within the first region, the calculation module will calculate a second region according to the detected distance and the detected direction, and the object search module will search the obstacle image within the second region. Wherein the second region is greater than the first region.

Preferably, the calculation module calculates the first region or the second region respectively according to a default condition of the external obstacle situated at a ground or non-ground position.

Preferably, the camera image is one of a plurality of continuous images captured by the camera module, and the object search module uses the plurality of images to execute a second image processing on the camera image within the second region to obtain an obstacle image.

To achieve the aforementioned objective, the present invention provides an obstacle detection system applied in a mobile vehicle, and the obstacle detection system comprises an object detection module, a camera module, a processing module and a display module. The object detection module is provided for generating a detected distance and a detected direction of at least one external obstacle, and the object detection module can be a sonar detection device or a radar detection device. The camera module is provided for capturing a camera image which includes an obstacle image. The processing module calculates a first region for the obstacle image in the camera image according to the detected distance and the detected direction, and executes a first image processing on the camera image within the first region to obtain the obstacle image, so as to calculate a distance from the obstacle and highlight the obstacle image in the camera image. If the obstacle image cannot be searched within the first region, the processing module will calculate a second region according to the distance and the direction, and execute a second image processing on the camera image within the second region to search the obstacle image. The display module is provided for displaying the camera image with the highlighted obstacle image.

To achieve the aforementioned objective, the present invention further provides an obstacle detection method applied in a mobile vehicle. The obstacle detection method comprises steps of: using an object detection module to generate a detected distance and a detected direction of at least one external obstacle; capturing a camera image by a camera module, wherein the camera image includes an obstacle image; using a calculation module to calculate a first region where the obstacle is possibly located in the camera image according to the detected distance and the detected direction; and executing a first image processing on the camera image within the first region by an object search module to obtain the obstacle image.

To sum up, in the obstacle detection system and the obstacle detection method thereof in accordance with the present invention, a radar or a sonar detecting technology and an image capturing technology are provided for detecting an obstacle in the surrounding environment while driving a motor vehicle. An object of the obstacle is marked in the image by any forms, such as a selected frame or a color. A distance between the motor vehicle and the obstacle is displayed in form of a figure or a numeric value. Based on the more detailed driving information provided by the obstacle detection system, the drivers may know about any change of the surrounding environment clearly, so as to enhance the safety and convenience of driving a motor vehicle.

### BRIEF DESCRIPTION OF THE DRAWINGS

FIG. 1 is a schematic view of an obstacle detection system in accordance with a first preferred embodiment of the present invention;

FIG. 2 is a schematic view of an obstacle detection system in accordance with a second preferred embodiment of the present invention;

FIG. 3 is a flow chart of an obstacle detection method of the present invention;

FIG. 4 is a first schematic view of an obstacle detection system and a method thereof in accordance with a third preferred embodiment of the present invention;

FIG. 5 is a second schematic view of an obstacle detection system and a method thereof in accordance with the third preferred embodiment of the present invention;

FIG. 6 is a third schematic view of an obstacle detection system and a method thereof in accordance with the third preferred embodiment of the present invention;

FIG. 7 is a fourth schematic view of an obstacle detection system and a method thereof in accordance with the third preferred embodiment of the present invention;

FIG. 8 is a fifth schematic view of an obstacle detection system and a method thereof in accordance with the third preferred embodiment of the present invention; and

FIG. 9 is a flow chart of an obstacle detection system and a method thereof in accordance with the third preferred embodiment of the present invention.

### DETAILED DESCRIPTION OF THE PREFERRED EMBODIMENTS

The technical characteristics of the obstacle detection system and obstacle detection method of the present invention will become apparent with the detailed description of preferred embodiments and the illustration of related drawings as follows. It is noteworthy to point out that same numerals are used in the following preferred embodiments to represent respective elements.

The obstacle detection system and obstacle detection method of the present invention are mainly applied in a mobile vehicle which can be a motor vehicle of any model or design, or any other transportation means capable of carrying passengers. The motor vehicle used as an example is a car in each of the following preferred embodiments, but the present invention is not limited to the motor vehicle only.

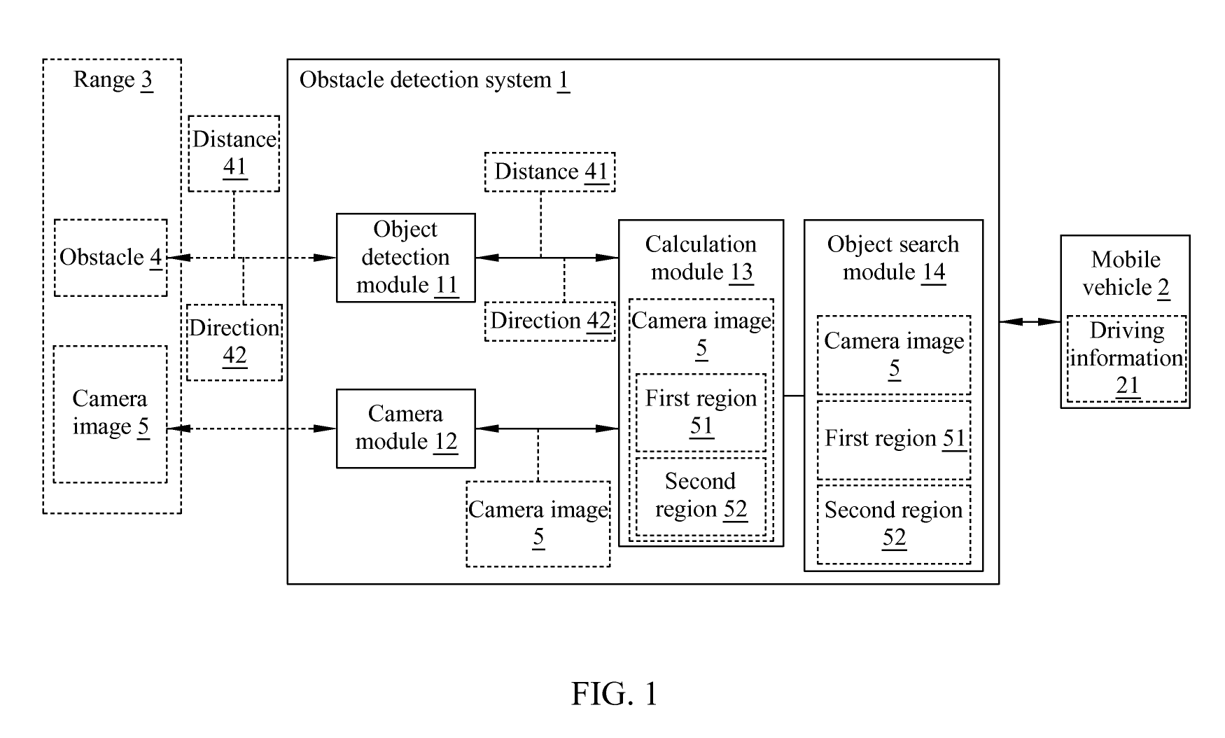

With reference to FIG. 1 for a schematic view of an obstacle detection system in accordance with the first preferred embodiment of the present invention, the obstacle detection system 1 is applied in a mobile vehicle 2 and installed at the front or rear of the mobile vehicle 2, but the invention is not limited to such arrangement only. The obstacle detection system 1 comprises an object detection module 11, a camera module 12, a calculation module 13 and an object search module 14, and the calculation module 13 is electrically coupled to the object detection module 11, the camera module 12 and the object search module 14, respectively. The object detection module 11 can be a radar detection device or a sonar detection device, wherein the radar detection device may apply infrared radar detection or ultrasonic radar detection etc. It is only exemplary and not limited to these devices only. The camera module 12 can be a camera of any design or model. Wherein, the obstacle detection system 1 further comprises a storage module (not shown in the figure) for storing images captured by the camera module 12 or data processed by the calculation module 13 and the object search module 14.

In this preferred embodiment, the object detection module 11 can perform detection by moving horizontally or vertically to detect whether an obstacle 4 exists within a range 3 of a surrounding external environment of the mobile vehicle 2. If an obstacle 4 exists within the range 3, the object detection module 11 will detect a distance 41 and a direction 42 of the obstacle 4 and transmit information of the detected distance 41 and the detected direction 42 to the calculation module 13. The camera module 12 is provided for taking a picture of the range 3 to obtain a camera image 5, which includes an image corresponding to the obstacle 4. Wherein, the camera image 5 may be a continuous image including a plurality of images. The camera module 12 can transmit the captured camera image 5 to the calculation module 13 to perform processing at a later stage. The calculation module 13 further calculates a first region 51 that is a possible position where the obstacle 4 may situate in the camera image 5 according to the detected distance 41 and the detected direction 42 of the obstacle 4. Wherein, the calculation module 13 determines whether the obstacle is situated at a ground or a non-ground position, and then starts calculating the first region 51. After the first region 51 is calculated, the object search module 14 starts executing a first image processing to the first region 51 to search a position of the obstacle 4 in the first region 51 and obtain an image of the obstacle 4, and then marks the image of the obstacle 4. The mark can be a sign, a color or a selected frame. When the object search module 14 obtains the image of the obstacle 4, the calculation module 13 is provided for calculating an actual distance between the obstacle 4 and the mobile vehicle 2, and displaying the distance in the camera image 5 in form of a number, a figure, or any other means.

From the description above, if the object search module 14 cannot search the image of the obstacle 4 in the first region 51, the calculation module 13 will calculate a second region 52 according to the detected distance 41 and the detected direction 42 of the obstacle 4. The object search module 14 will execute a second image processing to the second region 52 to search the obstacle 4 in the second region 52, wherein the second region 52 is greater than the first region 51 in order to expand the range of the search region.

From the description above, the calculation module 13 further calculates the distance between the obstacle 4 and the mobile vehicle 2 according to driving information 21 of the mobile vehicle 2. The driving information 21 includes a driving speed, a turning angle of a steering wheel, which can be used for calculating the distance between the obstacle 4 and the mobile vehicle 2 more accurately. In this preferred embodiment, the object detection module 11 and the camera module 12 are used for detecting and capturing images, respectively. The sequence of these operations is only an aspect of the embodiment. The object detection module 11 and the camera module 12 can also be operated simultaneously for the detection and the photography, or the camera module 12 may capture an image before the detection module 11 is used for the detection. However, the invention is not limited to the arrangement in this preferred embodiment only.

The calculation module 13 and the object search module 14 can be implemented through executing software by processing chip. The first image processing and the second image processing can be implemented by different image processing algorithms respectively.

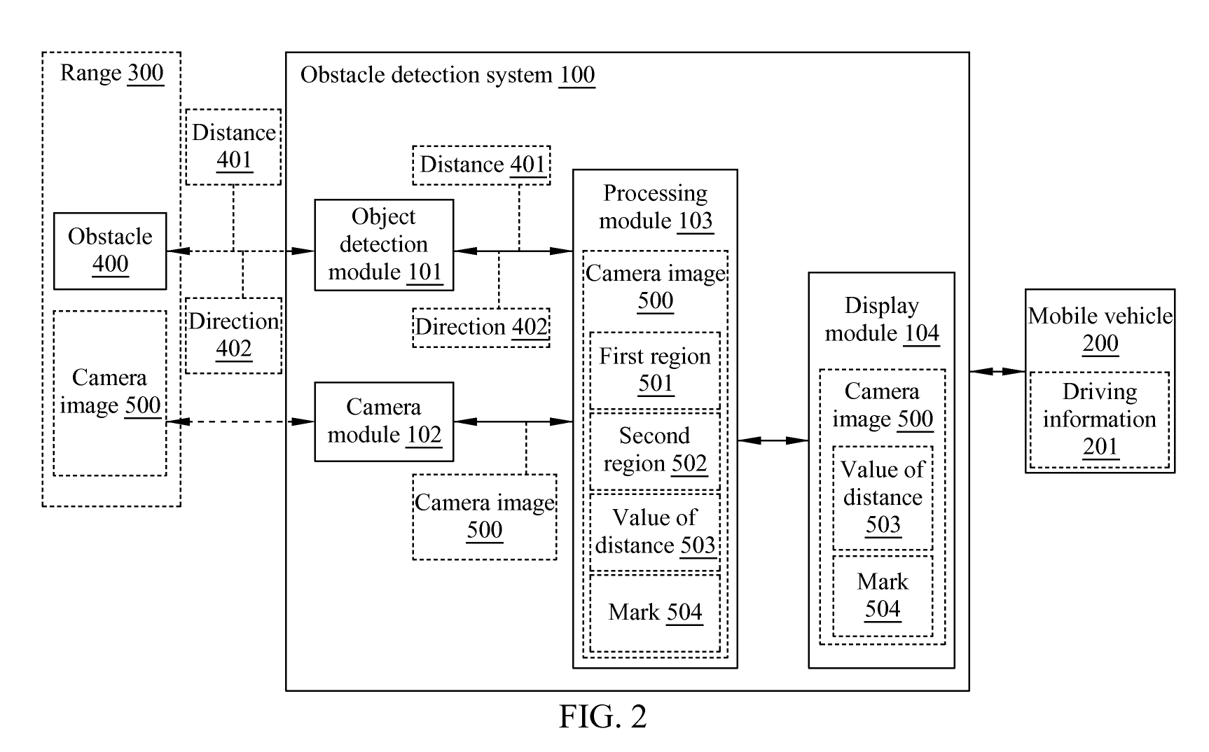

With reference to FIG. 2 for a schematic view of an obstacle detection system in accordance with the second preferred embodiment of the present invention, the obstacle detection system 100 is installed in a mobile vehicle 200. The obstacle detection system 100 comprises an object detection module 101, a camera module 102, a processing module 103 and a display module 104. The processing module 103 is electrically coupled to the object detection module 101, the camera module 102 and the display module 104.

In this preferred embodiment, the object detection module 101 can be used for detecting the surrounding external environment while driving a mobile vehicle 200. If an obstacle 400 is detected within a range 300 of the external environment, the object detection module 101 will transmit information of the detected distance 401 and the detected direction 402 of the obstacle 400 to the processing module 103. In the meantime, the camera module 102 can capture the camera image 500 in the range 300, and the camera image 500 includes an image corresponding to the obstacle 400. The camera image 500 captured by the camera module 102 may be transmitted to the processing module 103. The processing module 103 may calculate a first region 501 where the obstacle 400 may situate in the camera image 500 according to the detected distance 401 and the detected direction 402 of the obstacle 400, and execute a first image processing to the first region 501 to search the position of the obstacle 400 in the first region 501 to obtain an image of the obstacle 400. If the processing module 103 cannot search the obstacle 400 in the first region 501, the processing module 103 will calculate a second region 502 according to the distance 401 and direction 402, and execute a second image processing to the second region 502 to search the position of the obstacle 400 in the second region 502 to obtain an image of the obstacle 400. If the image of the obstacle 400 is obtained in the first region 501 or the second region 502, the processing module 103 will calculate a value of distance 503 between the obstacle 400 and the mobile vehicle 200 according to driving information 201 of the mobile vehicle 200, and provide a mark 504 to the image of the obstacle 400 in the camera image 500. Finally, the processing module 103 transmits the calculated camera image 500 to the display module 104, and the display module 104 displays the camera image 500 labeled with the value of distance 503 and the mark 504. Wherein, the processing module 103 marks the image of the obstacle 400 by a sign, a color, or a selected frame, and the value of distance 503 is displayed in form of a numeric value or a chart.

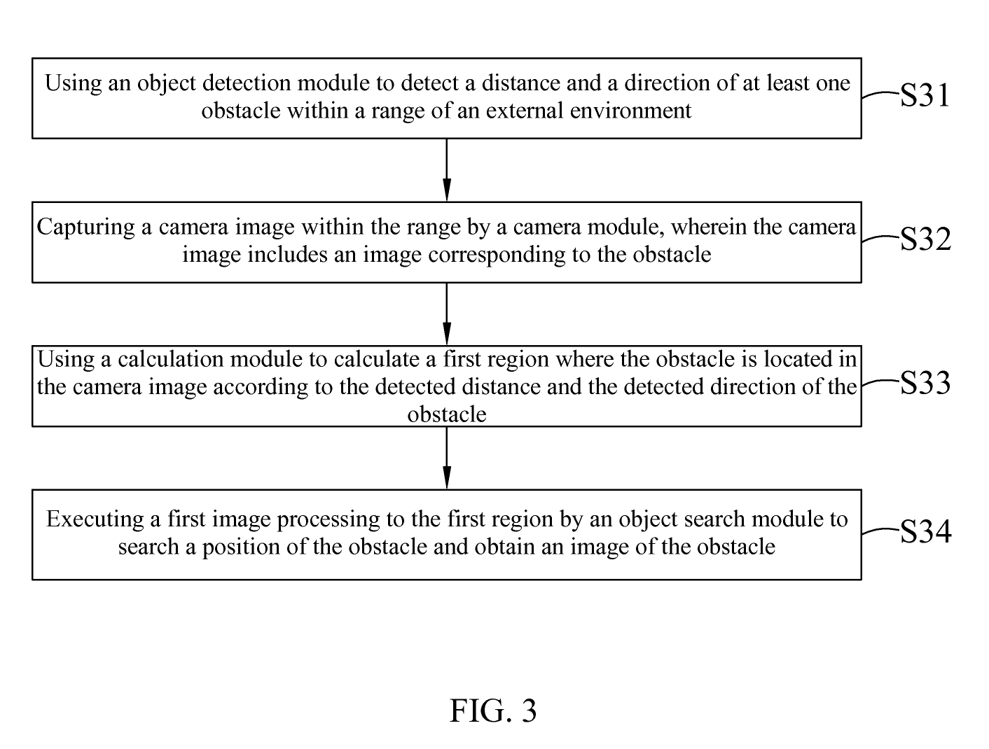

With reference to FIG. 3 for a flow chart of an obstacle detection method of the present invention, the obstacle detection method comprises the following steps: S31: Using an object detection module to detect a distance and a direction of at least one obstacle within a range of an external environment. S32: Capturing a camera image within the range by a camera module, wherein the camera image includes an image corresponding to the obstacle. S33: Using a calculation module to calculate a first region where the obstacle is located in the camera image according to the detected distance and the detected direction of the obstacle. S34: Executing a first image processing to the first region by an object search module to search a position of the obstacle and obtain an image of the obstacle.

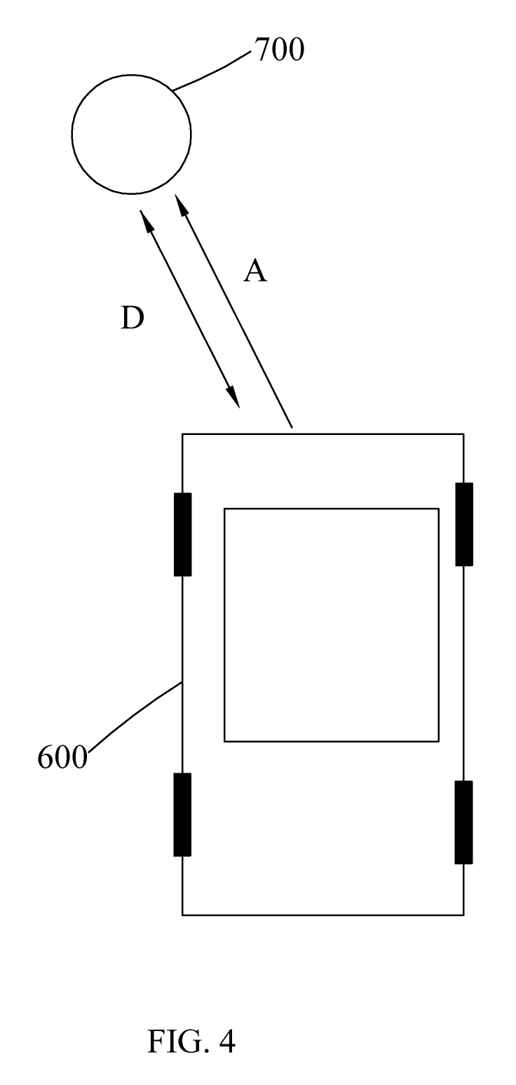

With reference to FIG. 4 for a first schematic view of an obstacle detection system and a method thereof in accordance with the third preferred embodiment of the present invention, the obstacle detection system of the present invention is installed in a car 600. When the car 600 is driving or reversing on a road and the obstacle detection system is turned on, the radar or sonar detection device (an active detection) in the obstacle detection system will detect an obstacle 700 within an effective range of the car 600. If the obstacle 700 is detected, a distance D and a direction A of the obstacle 700 will be transmitted back to a processing chip installed in the obstacle detection system.

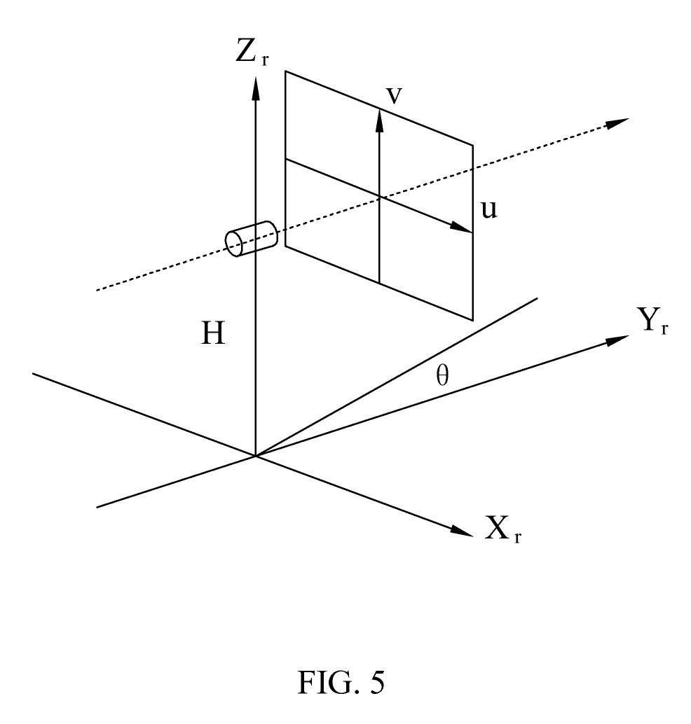

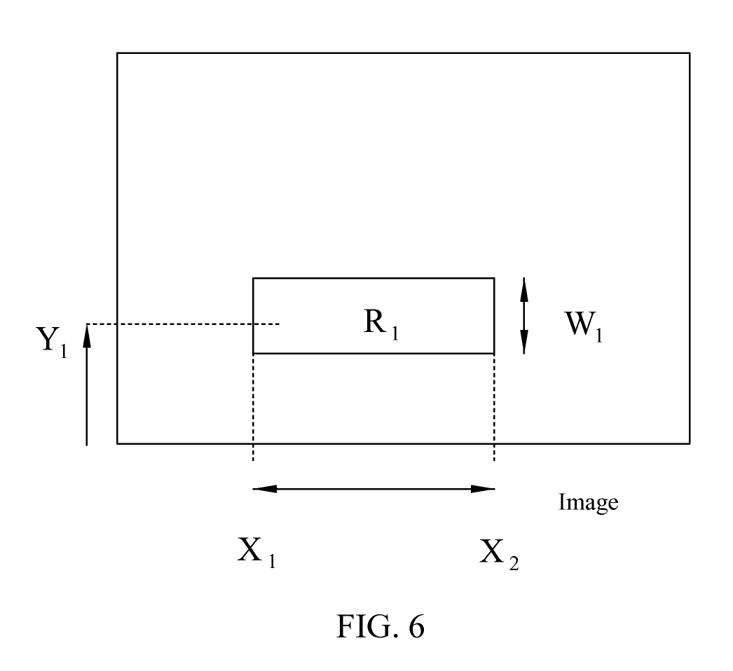

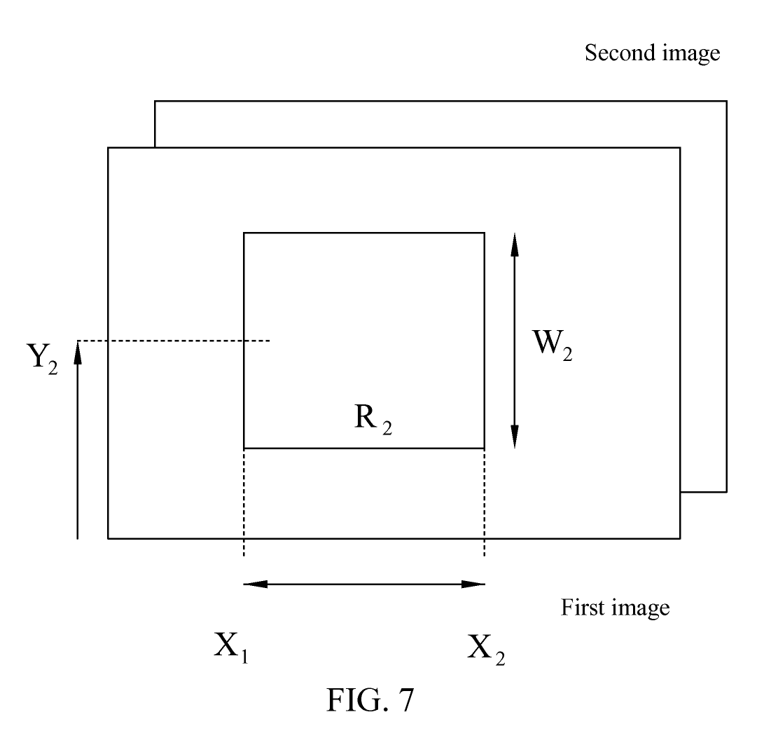

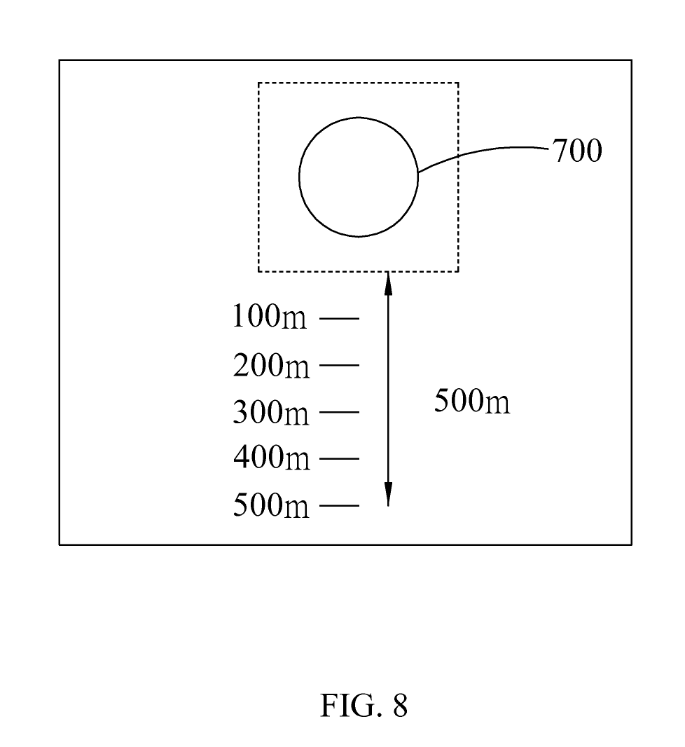

With reference to FIG. 5 for a second schematic view of an obstacle detection system and a method thereof in accordance with the third preferred embodiment of the present invention, FIG. 6 for a third schematic view of an obstacle detection system and a method thereof in accordance with the third preferred embodiment of the present invention, FIG. 7 for a fourth schematic view of an obstacle detection system and a method thereof in accordance with the third preferred embodiment of the present invention, and FIG. 8 for a fifth schematic view of an obstacle detection system and a method thereof in accordance with the third preferred embodiment of the present invention, when a radar or sonar detection device is provided for obtaining a distance D and a direction A of an obstacle 700, and a camera comprised in the obstacle detection system captures a camera image within an effective range. When capturing the camera image from the effective range, the obstacle 700 is also captured into the camera image as an image object of the camera image. Now, the processing chip calculates a region where the obstacle 700 may locate in the camera image according to the detected distance D and the detected direction A of the obstacle 700. The method of calculating the region is performed based on the condition of that the obstacle 700 is situated at a ground or a non-ground position. If the processing chip computes a region, image processing will be performed according to the captured camera image to search a position of the obstacle 700 in the region. The operation of the region calculating and the image processing are described as follows:

1. The obstacle 700 is situated on a ground and the same plane, and the processing chip calculates a first region R1 based on this condition:

After a camera is installed to a car 600, each of the parameters and projection angles of the camera is known, so that the distance between the obstacle 700 on the ground and the car 600 can be obtained from the position of the image of the obstacle 700 in the camera image in advance, and an appropriate range of angle can be set for searching the obstacle 700. By using the projection principle, the coordinates (Xc, Yc, Zc) of the camera are projected onto a coordinate plane (u, v) of the camera image as shown in FIG. 5. In calculating the conversion of the space, it is necessary to obtain the height H of the camera lens first, and the values of eᵤ and eᵥ related to the viewing angle of the camera lens. If the world coordinates are Xr and Yr, the coordinate values u and v of the camera image will be obtained by substituting Xr and Yr in the following formula. u=eᵤ·Xᵣ/Yᵣ, v=eᵥ·(Zᵣ−H)/Yᵣ, wherein Zᵣ=m_{θ}·Yᵣ, and m_{θ} represents the slope of a road. Therefore, according to the above-mentioned correlation, the distance on the world coordinates can be used to calculate the first region R1 where the obstacle 700 may situate in the camera image, as shown in FIG. 6. The first region R1 is the region of the obstacle 700 located Y1away from the camera and falling within a range of X1˜X2 on both sides with a default minimum height W1 of the obstacle 700. The processing chip further executes a first image processing to the first region R1 to search the position of the obstacle 700. In the captured camera image, the brightness differences, characteristic differences and material differences between the obstacle 700 and the background are used for executing the first image processing, so that the obstacle 700 existing in the camera image can be searched. From the description above, the processing chip determines the position of the obstacle 700 according to a single static image in the camera image captured by the camera to calculate the first region R1, but the invention is not limited to such arrangement.

2. The obstacle 700 is not situated on the same plane of the ground (the distance from the obstacle 700 is close to the distance to the contact point of the ground), and the processing chip calculates a second region R2 according to this condition:

If the processing chip cannot search the position of the obstacle 700 in the first region R1, or executing the calculation with the initial condition of that the obstacle detection system is set for an obstacle 700 not situated on the ground, the processing chip will calculate the second region R2.

Since the camera image obtained from the camera is a continuous image composed of a plurality of images, it may re-determine the position that the obstacle 700 may locate by using a technology of image comparison to compare two or more images. For example, methods including optical flow, feature detection and tracking, environment appearance etc. can be used for locating an object (the obstacle 700) moving in the camera image, or a possible 3D object with parallax (the obstacle 700). At the moment, it may re-calculate a second region R2 according to the distance Y2 and the possible range X1˜X2 of the direction angle detected by the radar detection device. Since no obstacle 700 can be searched in the first region R1, a new default height W2 is set for the obstacle 700, so that the second region R2 is greater than the first region R1 to expand the searching range of the region of the obstacle 700. Furthermore, a second image processing to the second region R2 is executed to search the obstacle 700 as shown in FIG. 7.

In the aforementioned calculation method, when the processing chip calculates a region, the processing chip performs the calculation according to the position (a ground or a non-ground position) that the obstacle 700 situated, and the detected distance D and the detected direction A of the obstacle 700, so as to calculate the first region R1 wherein the obstacle 700 may locate in the image, and further search the position of the obstacle 700 within the first region R1. If the obstacle 700 cannot be searched in the first region R1, the processing chip will uses a first image and a second image (since the image captured by the camera is an image, which may divide into a first image, a second image etc.) to re-calculate a second region R2 according to the distance D and the direction A. The second region R2 is greater than the first region R1 so as to expand the searching range of the obstacle 700. When the processing chip performs a searching for an obstacle 700 in the second region R2, an image processing is performed according to the first image and the second image. If the obstacle 700 is searched in the first region R1 or the second region R2, the processing chip will position the obstacle 700. The actual distance between the obstacle 700 and the car 600 is calculated according to driving information (including driving speed and turning angle of steering wheel) of the car 600, and the obstacle 700 is marked in the camera image by a selected frame, a color, or any other obvious method. Finally, the marked camera image is displayed on a display device. Besides the marked camera image, the display device also displays the distance between the obstacle 700 and the car 600 by a numeric value or a figure, and displays the chart of the actual distance between the obstacle 700 and the car 600 on a road, as shown in FIG. 8. Thus, a user can clearly understand about the changes of the surrounding environment of the car 600 to improve the driving safety.

From the description above, when the processing chip calculates a region, the calculation is not limited to that calculating the region when the obstacle 700 is situated on the ground first, but analyzing a plurality of images to directly determine a larger region (in other words, the obstacle 700 is directly determined situated on the non-ground position). The foregoing example is provided for illustrating the invention only, but not intended for limiting the scope of the invention.

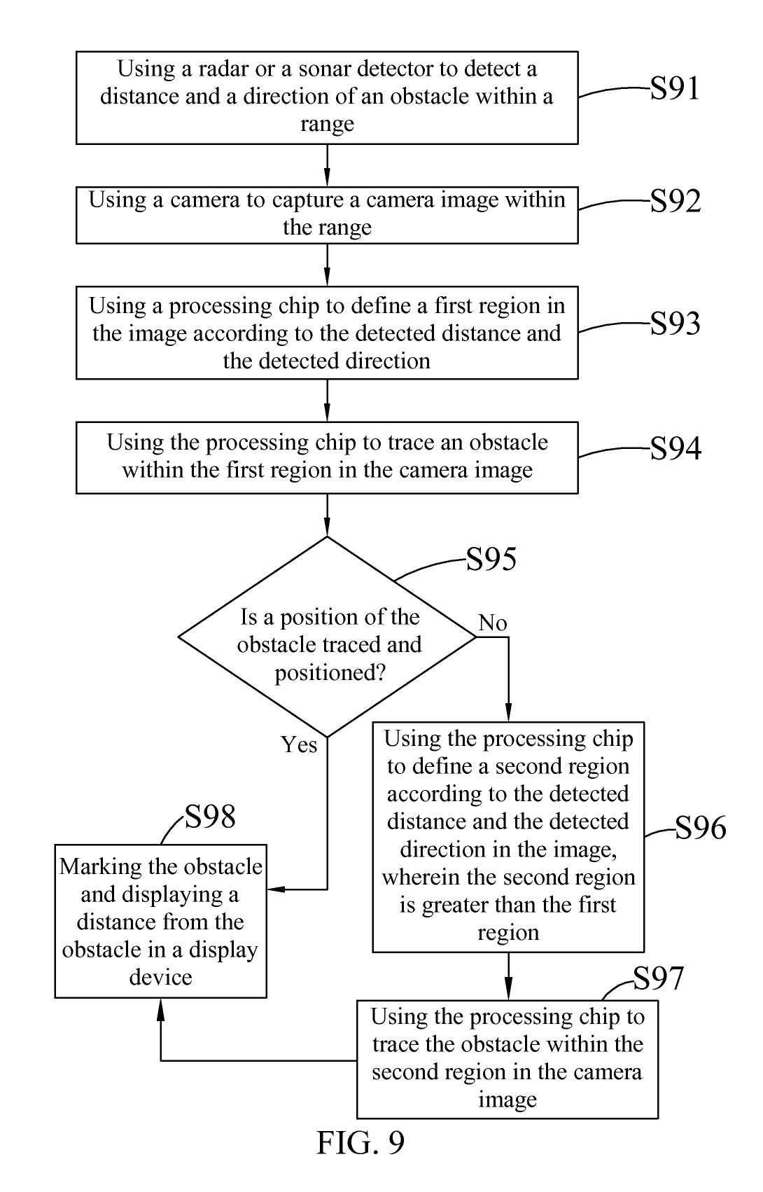

With reference to FIG. 9 for a flow chart of the obstacle detection system and method thereof in accordance with the third preferred embodiment of the present invention, the method comprises following steps: S91: Using a radar or a sonar detector to detect a distance and a direction of an obstacle within a range. S92: Using a camera to capture a camera image within the range. S93: Using a processing chip to define a first region in the image according to the detected distance and the detected direction. S94: Using the processing chip to trace an obstacle within the first region in the camera image. S95: Determining whether a position of the obstacle is traced and positioned; if yes, then go to step S98, or else go to step S96. S98: Marking the obstacle and displaying a distance from the obstacle in a display device. S96: Using the processing chip to define a second region according to the detected distance and the detected direction in the image, wherein the second region is greater than the first region. S97: Using the processing chip to trace the obstacle within the second region in the camera image, and then goes to step S98.

In summation of the description above, the obstacle detection system and obstacle detection method of the present invention can be used to calculate the distance between the obstacle and the cars and the direction of position of the obstacle more accurately by integrating the radar or sonar detector with the image capturing technology. The position of the obstacle may further be marked in the image in the screen, and the distance between the obstacle and the car and mark of the actual distance between the obstacle and the car on a road may also be displayed. Thus, the safety of drivers when driving the cars may be efficiently improved.

The descriptions above are only exemplary but not limited. While the invention has been described by means of specific embodiments, numerous modifications and variations could be made thereto by those skilled in the art without departing from the scope and spirit of the invention set forth in the claims.

What is claimed is:

1. An obstacle detection system applied in a mobile vehicle, comprising:
an object detection module, generating a detected distance and a detected direction of at least one external obstacle;
a camera module, capturing a camera image including an obstacle image;
a calculation module, calculating a first region for the obstacle image in the camera image according to the detected distance and the detected direction; and
an object search module, executing a first image processing on the camera image within the first region to obtain the obstacle image.

2. The obstacle detection system of claim 1, wherein the calculation module calculates a distance from the obstacle when the object search module obtains the obstacle image.

3. The obstacle detection system of claim 2, wherein the calculation module calculates the distance according to driving information of the mobile vehicle.

4. The obstacle detection system of claim 1, wherein the obstacle image is highlighted in the camera image.

5. The obstacle detection system of claim 1, wherein the object detection module is a sonar detection device or a radar detection device.

6. The obstacle detection system of claim 1, wherein if the object search module can not search the obstacle image within the first region, the calculation module calculates a second region according to the detected distance and the detected direction, and the object search module searches the obstacle image within the second region, and the second region is greater than the first region.

7. The obstacle detection system of claim 6, wherein the calculation module calculates the first region or the second region respectively according to a default condition of the external obstacle situated at a ground or a non-ground position.

8. The obstacle detection system of claim 6, wherein the camera image is one of a plurality of continuous images captured by the camera module, and the object search module uses the plurality of images to execute a second image processing on the camera image within the second region to obtain the obstacle image.

9. An obstacle detection system applied in a mobile vehicle, comprising:
an object detection module, generating a detected distance and a detected direction of at least one external obstacle, and the object detection module being a sonar detection device or a radar detection device;
a camera module, capturing a camera image which includes an obstacle image;
a processing module, calculating a first region for the obstacle image in the camera image according to the detected distance and the detected direction, and executing a first image processing on the camera image within the first region to obtain the obstacle image, so as to calculate a distance from the obstacle and highlight the obstacle image in the camera image; if the obstacle image being not able to be searched within the first region, the processing module calculating a second region according to the distance and the direction and executing a second image processing on the camera image within the second region to search the obstacle image; and
a display module, displaying the camera image with the highlighted obstacle image.

10. The obstacle detection system of claim 9, wherein the processing module calculates the first region or the second region respectively according to a default condition of the obstacle situated at a ground or a non-ground position.

11. The obstacle detection system of claim 9, wherein the processing module further calculates the distance according to driving information of the mobile vehicle.

12. The obstacle detection system of claim 9, wherein the camera image is one of a plurality of continuous images captured by the camera module, and the processing module uses the plurality of images to execute the second image processing on the camera image within the second region.

13. An obstacle detection method applied in a mobile vehicle, comprising steps of:
using an object detection module to generate a detected distance and a detected direction of at least one external obstacle;
capturing a camera image by a camera module, wherein the camera image includes an obstacle image;
using a calculation module to calculate a first region where the obstacle is possibly located in the camera image according to the detected distance and the detected direction; and
executing a first image processing on the camera image within the first region by an object search module to obtain the obstacle image.

14. The obstacle detection method of claim 13, further comprising a step of:
using the calculation module to calculate a distance from the obstacle according to driving information of the mobile vehicle when the object search module obtains the obstacle image.

15. The obstacle detection method of claim 13, further comprising a step of:
highlighting the obstacle image in the camera image.

16. The obstacle detection method of claim 13, further comprising steps of:
using the calculation module to calculate a second region according to the detected distance and the detected direction and searching the obstacle image within the second region by the object search module if the object search module being not able to search the obstacle image within the first region, wherein the second region is greater than the first region.

17. The obstacle detection method of claim 16, further comprising a step of:
using the calculation module to calculate the first region or the second region respectively according to a default condition of the external obstacle situated at a ground or a non-ground position.

18. The obstacle detection method of claim 16, further comprising a step of:
executing a second image processing on the camera image within the second region by the object search module according to a plurality of continuous images containing the camera image, to search the obstacle image.
